(19) United States
(12) Patent Application Publication
(10) Pub. No.: US 2015/0151520 A1
(43) Pub. Date: Jun. 4, 2015

(54) Tear resistant paperboard structure and method

(71) Applicant: Blair Holland, Attleboro, MA (US)

(72) Inventor: Blair Holland, Attleboro, MA (US)

(21) Appl. No.: 14/121,211

(22) Filed: Aug. 12, 2014

Related U.S. Application Data
(60) Provisional application No. 61/963,290, filed on Nov. 29, 2013.

(51) Int. Cl. B32B 27/10; B32B 7/12; B32B 27/20; B32B 27/32; B32B 27/16

(52) U.S. Cl. CPC B32B 27/10; B32B 27/32; B32B 27/16; B32B 27/20; B32B 7/12; B32B 2250/40; B32B 2255/12; B32B 2255/20; B32B 2264/102; B32B 2553/00; B32B 2307/5825

(57) ABSTRACT

A laminate sheet construction and methods for producing a laminate sheet are disclosed. More particularly, the present invention relates to a laminated material having a paperboard core with extrusion laminated adhesive layers bonding films to both sides of the paperboard core.

### CROSS-REFERENCE TO RELATED APPLICATIONS

The present application is related to, claims the earliest available effective filing date(s) from (e.g., claims earliest available priority dates for other than provisional patent applications; claims benefits under 35 USC §119(e) for provisional patent applications), and incorporates by reference in its entirety all subject matter of the following listed application(s) (the “Related applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related application(s) to the extent such subject matter is not inconsistent herewith:

U.S. provisional patent application 61/963,290 entitled “Tear Resistant Paperboard Structure and Method”, naming Blair Holland as inventor, filed 29 Nov. 2013.

### FIELD OF USE

The present invention relates to a laminate sheet construction, structures made from the same, and methods for producing said structures. More particularly, the present invention relates to a laminated material having a paperboard core with extrusion laminated adhesive layers bonding films to both sides of the paperboard core.

### DESCRIPTION OF PRIOR ART

### Background

Known in the art are cartons for packaging various consumer products. Such cartons are made substantially of a paperboard material, and often include separate components which are movable with respect to one another. For example, known in the art are drug dispensing cartons or the like, where a sleeve houses an inner sliding member, and the consumer product, i.e. tablets, capsules, etc., are packaged in the inner sliding member. In order to access the drug units, a consumer slides the sliding member out of the sleeve. The sliding member may be provided in the form of a paperboard card or drawer. The same sliding member or another sliding member may provide information (instructions, disclaimers, etc.) concerning the product, for example an information card or a small booklet which is slideably engaged with the sleeve of the packaging.

Moreover, conventional packaging materials, such as for packaging unit dose pharmaceuticals, lack high tear-resistance and burst-resistance, which are desirable characteristics for various packaging applications including pharmaceutical packaging. Child resistance is a feature particularly desirable for unit dose pharmaceutical packaging to ensure that the package has sufficient integrity against tampering by children.

There is thus a need for an improved package and packaging material for providing improved tolerance in packages. Known in the art are various paperboard materials, including various tear-resistant paperboard materials, for manufacturing such packaging products. A conventional packaging is made of a tear-resistant paperboard laminate comprising a paperboard layer which is bonded to a tear-resistant polymer film such as polyethylene, polyester, or the like. The paperboard is clay coated, on the exposed side, for printability. Thus the resulting laminate has a clay coated paperboard side and a film side.

Unfortunately, a typical tear-resistant packaging material may become significantly more prone to tear propagation once an initiated tear point is formed in the packing material. While some packaging containers, such as clamshell containers, may be constructed without initiated tear points, other packaging containers, such as cartons and boxes, are formed from die-cut blanks that may inherently include initiated tear points. For example, a carton blank may include initiated tear points located where the major and minor end flaps connect to the body panels. Therefore, packaging containers formed with initiated tear points generally require packaging materials having a greater degree of tear-resistance.

Cost is a significant concern when manufacturing packaging materials. Each additional component or layer added to packaging material to improve tear-resistance also increases overall manufacturing costs. As manufacturing costs increase, so too does the final cost of the packaged product. Accordingly, those skilled in the art continue with research and development efforts in the field of tear-resistant packaging materials.

Moreover, despite advances in multi-layer film technology, the use of such films as the strength layer in a laminated structure with paperboard is still characterized by relatively poor tear characteristics. A conventional tear-resistant material has tear strength as measured by the Elmendorf tear propagation test of approximately 350 grams of force in machine direction and 400 grams of force in cross direction. The poor tear characteristics of the paperboard are imparted to the cross-laminated layers and the tear propagates through each of the layers. Also, in fabricating products, the dissimilar materials of such laminates can present a number of problems including poor adhesion of the film to the paperboard surface, which can result in delaminating and other undesirable characteristics in the finished laminated product.

Multi-layer paperboard structures exist in the prior art and exhibit high tear-resistance, dimensional stability (independent of the relative humidity of the environment, without curling or warping of the laminated substrate), and printability on both sides of laminated substrate.

However, there is a need for an improved laminate with greater tear resistance and improved durability. Hence, in light of the aforementioned, there is a need for an improved packaging board which, by virtue of its design and components, would overcome some of the above-discussed prior art concerns as well as provide superior tear resistance to that which currently exists in the art.

### SUMMARY OF THE INVENTION

The object of the present invention is to provide a product and process which, by virtue of its design and components, satisfies some of the above-mentioned needs and is thus an improvement over other related packaging, tear-resistant paperboard structures and/or methods known in the prior art.

It is an object of the present invention to provide a laminated paperboard structure having a paperboard core with extrusion laminated adhesive layers bonding films to both sides of the paperboard core.

It is another object of the present invention to provide a laminated paperboard structure having a paperboard core with extrusion laminated adhesive layers bonding films to both sides of the paperboard core, the laminated structure having an Elmdorf tear resistance at least 600 lbf in the MD direction and 600 lbf in the CD direction (Tappi T414).

It is another object of the present invention to provide a laminated paperboard structure which utilizes Polyolefin and Polyester films as the bonded film, and in the preferred embodiment an LLDPE (octane) based blown film.

It is another object of the present invention to provide a laminated paperboard structure which utilizes a paperboard core having a clay coating to promote increased tear strength through disassociation of the paperboard and film layers.

It is another object of the present invention to provide a laminated paperboard structure which utilizes extrusion laminate adhesive layers having a polyethylene/calcium carbonate blend to decrease cost and promote thermal conductivity throughout the structure.

It is another object of the present invention to provide a laminated paperboard structure that does not deform due to changes in ambient moisture and is durable and water resistant.

It is another object of the present invention to provide a packaging which provides double-sided printability and includes corona treated film surfaces.

It is another object of the present invention to provide a laminated paperboard structure for improved packaging.

In accordance with the present invention, the above mentioned objects are achieved, as will be easily understood, by a tear-resistant paperboard structure such as the one briefly described herein and such as the one exemplified in the accompanying drawings.

According to embodiments of the present invention, there is provided a dimensionally stable, multi-layer paperboard structure that may be processed with conventional folding carton manufacturing equipment and techniques to form a multitude of tear-resistant prototypes.

According to an aspect of the present invention, there is provided a tear-resistant paperboard laminate for making a tear-resistant packaging structure.

In accordance with embodiments of the present invention, a tear-resistant paperboard structure includes a paperboard core layer having first and second opposite sides. The tear-resistant paperboard structure further includes a first film layer bonded to the first side of the Paperboard core layer, with a first bonding medium. The tear-resistant paperboard structure further includes a second film layer bonded to the second side of the Paperboard core layer, with a second bonding medium.

According to another aspect of the present invention, there is provided a use of the tear-resistant paperboard structure according to the present invention for making a packaging structure.

According to another aspect of the present invention, there is provided a method of manufacturing a tear-resistant paperboard structure. The method comprises steps of (a) providing a paperboard core layer having first and second opposite sides, (b) bonding with a first co-extrusion of adhesive material, a first film layer to the first side of the paperboard core layer; and (c) bonding, with a second co-extrusion of adhesive material, a second film layer to the second side of the paperboard core layer.

Preferably, the first and second film layers are corona treated only on the sides that are not laminated to the paperboard.

### BRIEF DESCRIPTION OF THE DRAWINGS

The foregoing and other objects, features, and advantages of the invention are apparent from the following detailed description taken in conjunction with the accompanying drawings in which:

FIG. 1 is a cross-sectional view of a paperboard laminate structure employing the principles of the present invention.

FIG. 2, 3 are schematic diagrams representing an adhesive laminating process employing the principles of the present invention, the process for making the paperboard laminate structure of the present invention.

### DETAILED DESCRIPTION

In the following description, the same numerical references refer to similar elements. The embodiments, geometrical configurations, materials mentioned and/or dimensions shown in the figures or described in the present description are preferred embodiments only, given for exemplification purposes only.

In the context of the present invention, any equivalent expression and/or compound words thereof known in the art will be used interchangeably, as apparent to a person skilled in the art. Furthermore, although the preferred embodiment of the present invention as illustrated in the accompanying drawings comprises components such as clay coatings, liquid adhesive, extrusion laminate concentrations, blown films etc., and although the preferred embodiment of the tear-resistant paperboard laminate and corresponding parts thereof consists of certain geometrical configurations as explained and illustrated herein, not all of these components and geometries are essential to the invention, unless indicated, and thus should not be taken in their restrictive sense, i.e. should not be taken as to limit the scope of the present invention. It is to be understood, as also apparent to a person skilled in the art, that other suitable components and cooperations therebetween, as well as other suitable geometrical configurations may be used for the tear-resistant paperboard laminate according to the present invention, as will be briefly explained herein and as can be easily inferred herefrom, by a person skilled in the art, without departing from the scope of the invention.

Furthermore, the order of the steps of the method described herein should not be taken as to limit the scope of the invention, as the sequence of the steps may vary in a number of ways, without affecting the scope or working of the invention, as can also be understood.

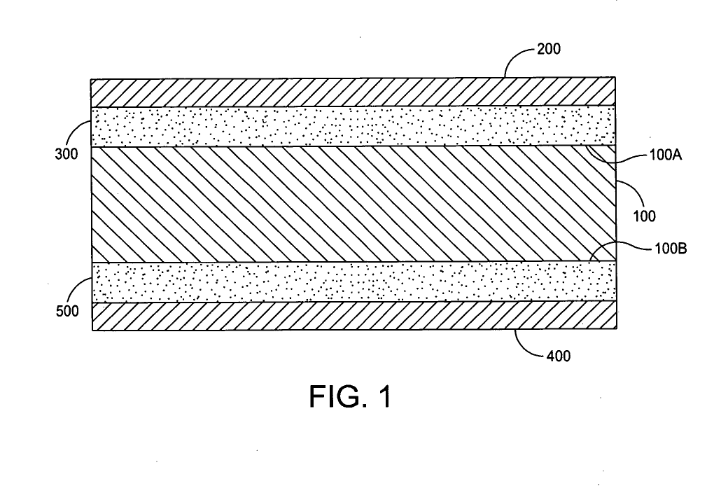

The tear-resistant paperboard structure of FIG. 1 includes a paperboard core layer 100 having first and second opposite sides, 100A and 100B respectively. The tear-resistant paperboard structure further includes a first film layer 200 bonded to the first side 100A of the Paperboard core layer 100, with a first bonding medium 300. The tear-resistant paperboard structure further includes a second film layer 400 bonded to the second side 100B of the Paperboard core layer 100, with a second bonding medium 500.

Preferably, paperboard core layer 100 is clay coated on at least one external side thereof, for promoting tear resistance. The external side of the paperboard is the side in contact with adhesive layers 300, 500. The clay coated paperboard core layer 100 creates a weak bond between the clay and paperboard 100, thereby creating a disassociation between the film layers 200, 400 and the paperboard 100, and promoting tear strength in the paperboard structure of FIG. 1.

The paperboard layer includes, but is not limited to, a substrate which may be: SBS (Solid Bleached Sulfate) 0.008″ to 0.024″, C1S (Coated 1 Side) board, CCNB (Clay Coated News Back) recycled board 0.008″ to 0.024″, TMP boards, low density clay coated boards, as well as uncoated cup stock, tag stock, and similar uncoated papers.

Preferably, the film layers, 200, 400, are substantially symmetrical in both dimension and material composition. Utilizing symmetrical films has been found to eliminate curl from the end products utilizing the present invention. When used in folding carton applications, if the paperboard base curls it would be difficult to print, die cut, and package the cartons.

In the preferred embodiments, film layers 200, 400 would be about 1.0 to about 4.0 mils thick. In the preferred embodiment, blown films have been shown to exhibit superior tear resistance in the present invention. Unlike highly oriented films such as OPP, PET, and MDO, the Polyolefin blown films including Linear Low Density Polyethylene blown film (LLDPE) have shown superior results, including the ability to absorb force and stretch (strain) when placed under tear forces. One example of such film is an Octane based LLDPE blown film. Polyolefin films including LDPE, LLDPE, mLLDPE, HDPE, EVA, EMA, and PP may be utilized as film layers 200, 400 in subject invention. These films may be manufactured through different processes such as blown extrusion and cast extrusion, and may include different levels of orientation such as cross lamination.

Utilizing an LLDPE blown film results in a paperboard structure having an Elmdorf tear resistance of at least 600 lbf in the MD direction and 600 lbf in the CD direction, when combined with the other features of the present invention. Other blown films may be utilized in the present invention. Additives such as HDPE, Metallocene, EVA, and EMA can be added to blown films to enhance certain characteristics such as stiffness, elongation, tensile strength, etc. Alternate films such as Polyester films may also be utilized in subject invention.

In the preferred embodiment, and further contributing to the total tear resistance of the paperboard structure, the film 200, 400 are only corona treated on the exposed sides to promote the ability for the surface to accept ink during the printing process. The unexposed side that contacts adhesive laminates 300, 500 and paperboard 100 is not corona treated to promote less bonding between the paperboard 100 and film 300, 500 substrates, which in turn increases the Elmdorf tear resistance.

In the preferred embodiment, and further contributing to the tear resistance of the present invention, the adhesive layers 300, 500 are an extrusion laminate blend with about 85% PE and about 15% CaCO3. The addition of CaCO3 enhance the thermal conductivity of layers 300, 500 by about 30% through the paperboard structure to facilitate the ability of the paperboard structure to heat seal when producing the final packaging product. Adhesive layers 300, 500 are from about 0.5 to about 2 mils thick. This is the minimum thickness that has shown to promote optimum tear resistance while still maintaining a sufficient bond between the film 200, 400 and paperboard 100 substrates. The thinner adhesive layers 300, 500 reduce the bond strength between the film 200, 400 and paperboard 100. Reducing the bond strength allows the film 200, 400 to tear independently from the paperboard 100 thereby increasing the tear resistance of the overall paperboard structure.

The following process of manufacture incorporates the various combinations and treatments of the materials previously described, and specifically incorporates the blends, thicknesses, and types of blown films, and adhesives as described herein.

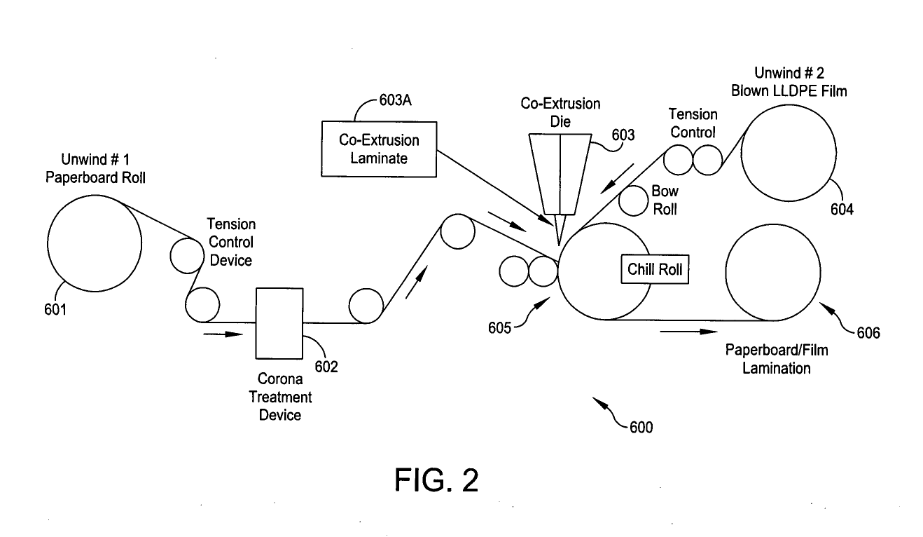

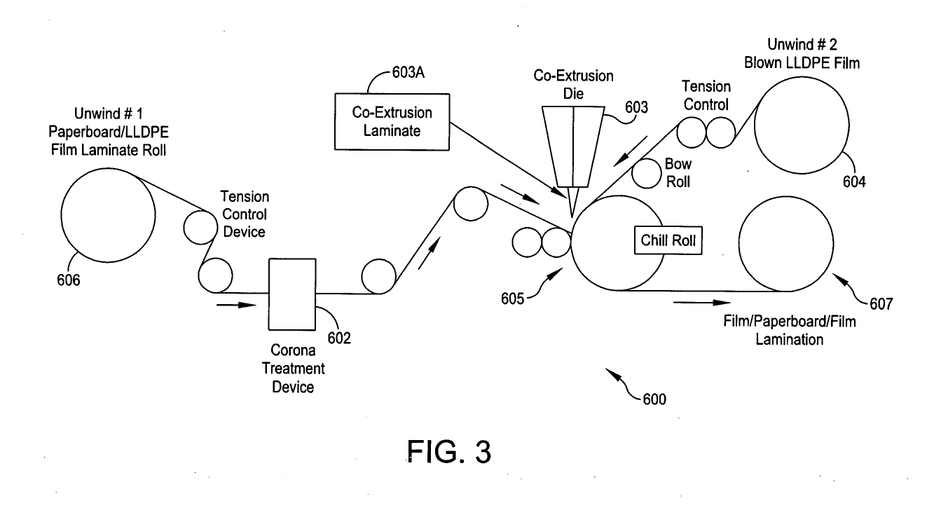

Referring now to FIGS. 2 and 3, there is shown method 600 of manufacturing a Tear Resistant Paperboard Structure according to a co-extrusion laminating process.

A paperboard 601 travels from an unwind roll to a corona treatment chamber 602, and if preferred is corona treated to increase the surface tension or dyne level of the paperboard. This corona treatment step is optional. The paperboard exits the corona treatment chamber 602 and travels to a co-extruder 603 to be coated with a co-extrusion adhesive layer 603A as previously defined herein. Thus, the first side of the paperboard 601 is coated with a co-extrusion adhesive 603A. Concurrently, an LLDPE Blown film 604 travels from another unwind roll coming into contact with the co-extrusion laminate 603A and they both enter between pressure rollers 605 to be joined together and rolled as a paperboard/film laminate 606.

Next, and referring to FIG. 3, the paperboard/film laminate 606 is gathered and passed for a second time through the extrusion lamination machinery. Paperboard/Film 606, being oriented for processing of the paperboard side only, travels from an unwind roll 606 to a corona treatment chamber 602 to increase the surface tension or dyne level of the paperboard side. This corona treatment step is optional. The paperboard exits the corona treatment chamber 602 and travels to a co-extruder 603 to be coated with a co-extrusion adhesive layer 603A as previously defined herein. Thus, the second side of the paperboard 301 is coated with a co-extrusion adhesive 303A. Concurrently, a second LLDPE Blown film 604 travels from another unwind roll coming into contact with the co-extrusion laminate 603A and they both enter between pressure rollers 605 to be joined together and rolled as a film/paperboard/film laminate 607.

It should be understood that the foregoing description is only illustrative of the invention. Thus, various alternatives and modifications can be devised by those skilled in the art without departing from the invention. Accordingly, the present invention is intended to embrace all such alternatives, modifications and variances that fall within the scope of the appended claims.

I claim:

1. A tear resistant paperboard structure, comprising:
a paperboard core layer having first and second opposite sides, at least one opposite side having a clay coating;
a top and bottom film layer, each having first and second opposite sides, said top and bottom first opposite sides defining the external surfaces of said packaging structure;
a first and second adhesive layers, said first and said second adhesive layers each having first and second opposite sides, said top film layer second opposite side bonded to said first adhesive layer first opposite side and said bottom film layer second opposite side bonded to said second adhesive layer first opposite side;
said first adhesive layer second opposite side bonded to said paperboard core layer first opposite side and said second adhesive layer second opposite side bonded to said paperboard core layer second opposite side.

2. A tear resistant paperboard structure as in claim 1, wherein said paperboard is selected from the group consisting of solid bleached sulfate, clay coated news back, TMP boards, low density clay coated boards, cup stock, and tag stock.

3. A tear resistant paperboard structure as in claim 2, wherein said solid bleached sulfate paper board has a thickness from about 0.008 to about 0.024 inches.

4. A tear resistant paperboard structure as in claim 2, wherein said clay coated news back has a thickness from about 0.008 to about 0.024 inches.

5. A tear resistant paperboard structure as in claim 1, wherein said top and bottom film layers are substantially symmetrical in both dimension and material composition.

6. A tear resistant paperboard structure as in claim 1, wherein said top and bottom film layers comprise blown films.

7. A tear resistant paperboard structure as in claim 6, wherein said blown films are between about 1.0 to about 4.0 mils in thickness.

8. A tear resistant paperboard structure as in claim 6, wherein said blown films are selected from the group consisting of LDPE, LLDPE, mLLDPE, HDPE, EVA, EMA, and PP Polyolefin films.

9. A tear resistant paperboard structure as in claim 7, wherein said paperboard structure has an Elmdorf tear resistance of at least 600 lbf in the MD direction and 600 lbf in the CD direction.

10. A tear resistant paperboard structure as in claim 1, wherein said top and bottom film layer first opposite sides are corona treated.

11. A tear resistant paperboard structure as in claim 1, wherein said first and second adhesive layers comprise an extrusion blend of about 85% PE and about 15% CaCO3.

12. A tear resistant paperboard structure as in claim 11, wherein said first and second adhesive layers are from about 0.5 to about 2 mils thick.

13. A tear resistant paperboard structure, comprising:
a paperboard core layer having first and second opposite sides, at least one opposite side having a clay coating;
a top and bottom film layer, wherein said top and bottom film layers comprise blown films, wherein said blown films are between about 1.0 to about 4.0 mils in thickness, said blown films each having first and second opposite sides, said top and bottom first opposite sides defining the external surfaces of said packaging structure;
a first and second adhesive layers, said first and said second adhesive layers each having first and second opposite sides, said top film layer second opposite side bonded to said first adhesive layer first opposite side and said bottom film layer second opposite side bonded to said second adhesive layer first opposite side;
said first adhesive layer second opposite side bonded to said paperboard core layer first opposite side and said second adhesive layer second opposite side bonded to said paperboard core layer second opposite side, wherein said first and second adhesive layers comprise an extrusion blend of about 85% PE and about 15% CaCO3, and wherein said first and second adhesive layers are from about 0.5 to about 2 mils thick, and
wherein said paperboard structure has an Elmdorf tear resistance of at least 600 lbf in the MD direction and 600 lbf in the CD direction.

14. A tear resistant paperboard structure as in claim 13, wherein said blown films are selected from the group consisting of LDPE, LLDPE, mLLDPE, HDPE, EVA, EMA, and PP Polyolefin films.

15. A tear resistant paperboard structure as in claim 13, wherein said paperboard is selected from the group consisting of solid bleached sulfate, clay coated news back, TMP boards, low density clay coated boards, cup stock, and tag stock.

16. A tear resistant paperboard structure as in claim 13, wherein said top and bottom film layers are substantially symmetrical in both dimension and material composition.

17. A tear resistant paperboard structure as in claim 13, wherein said top and bottom film layer first opposite sides are corona treated.
